(19) United States
(12) Patent Application Publication
(10) Pub. No.: US 2009/0228581 A1
(43) Pub. Date: Sep. 10, 2009

(54) System and Method for Enabling Virtual Playdates between Children

(75) Inventor: Frances Cairns, West Lake Hills, TX (US)

Correspondence Address: WINTHROP D. CHILDERS, 9855 FOX VALLEY WAY, SAN DIEGO, CA, 92127, US

(73) Assignee: CAIRN ASSOCIATES, INC., West Lake Hills, TX (US)

(21) Appl. No.: 12/043,571

(22) Filed: Mar. 6, 2008

(51) Int. Cl. G06F 15/173

(52) U.S. Cl. 709/224; 709/225

(57) ABSTRACT

The present invention concerns a system and method that enables children to have virtual playdates with each other within a virtual environment. The virtual environment is separately accessible by a child through a child interface and a parent through a parent control interface. The parent provides playdate control information to the system via the parent control interface. The child can then have playdates with other children based upon a scope defined by the playdate control information.

### FIELD OF THE INVENTION

The present invention concerns a method for providing an internet environment that is configured for younger children. In particular, the present invention provides a way for a child to take part in virtual playdates with other children according to parental approvals.

### BACKGROUND

Younger minors are encouraged by peers and schools to utilize the internet at an early age. This opens up the opportunity for considerable learning and entertainment opportunities. At the same time this exposes minors to dangers and inappropriate materials.

According to the National Center for Missing and Exploited Children, about one in seven children will receive a sexual solicitation on the Internet before their 17^{th} birthday. Most affected children do not report this exposure to their parents. In addition, roughly one third of children are exposed to unwanted pornography.

At the same time, children have a strong desire to engage in social networking and explore on the internet. Another issue this raises is the balance of time that a child spends on entertainment activities versus those that benefit her development. What is needed is a way that a child can fulfill the desire to socialize and explore on the internet while limiting exposures to those that are safe and appropriate.

### BRIEF DESCRIPTION OF THE FIGURES

FIG. 1 is a block diagram representation of a network incorporating the present invention.

FIG. 2 is a network diagram of the online environment of the present invention.

FIG. 3 is a block diagram of an environment or interface utilized by a child.

FIG. 4 is a block diagram of a control interface used by a parent of a child.

FIG. 5 is a flow chart representation of the process by which a parent utilizes parent control interface 26 to establish control parameters for each child account.

FIG. 6 is a flow chart representation of a parent setting a development goal for a child using parent interface 26.

FIG. 7 is a process flow representation of the inspire function (enabled by interface 50) being utilized.

FIG. 8A is a flow chart representation of a parent inviting another parent's child to be a Friend.

FIG. 8B is a flow chart representation of a parent establishing playdate parameters for one or more Friends.

FIG. 8C is a process flow representation of a parent and/or child accepting, scheduling, or initiating a playdate.

FIG. 8D is a flow chart representation of a parent or child scheduling a playdate.

FIG. 8E is a flow chart representation of a child initiating a spontaneous playdate.

FIG. 9A is a flow chart representation of a parent establishing an allowance for a child.

FIG. 9B is a flow chart representation of a child activating an allowance interface.

### DETAILED DESCRIPTION OF THE PREFERRED EMBODIMENTS

The present invention concerns a private online environment for children. In discussing some elements of this invention, “environments”, “web pages”, “spheres” and “interfaces” may be used interchangeably for the same element number. A “sphere” according to the present invention is a web page utilized by a child or parent. An “interface” is generally one or more web pages having some kind of inputs or controls for the child or parent to modify the online environment. The overall environment in this context is generally a superset of web pages and interfaces that provide the functions of the present invention.

The present invention concerns a private online environment for children with parent participation. This online environment provides children with a fun environment that is safe from online threats such as adults who may solicit or threaten children. In addition, the environment provides an opportunity for parents to participate in their children's' online experience for the purpose of providing development, fun, and security.

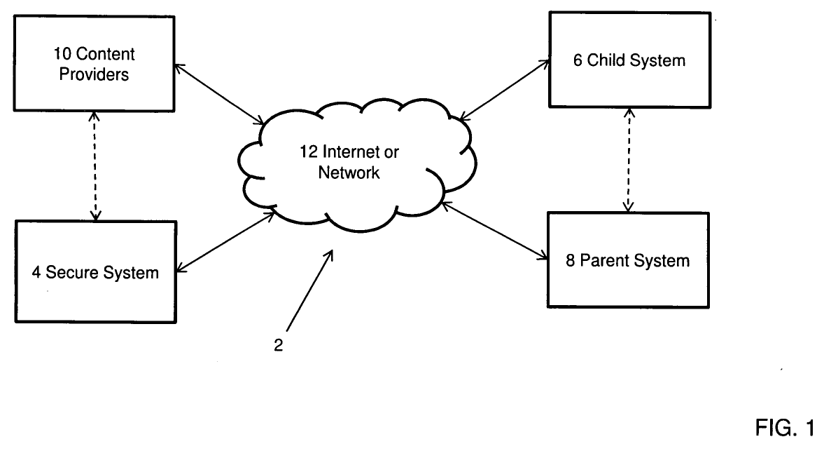

An overall network or system 2 according to the present invention is depicted in FIG. 1. A secure system 4 is coupled to a child system 6, a parent system 8, and content providers 10 via network or internet 12. As indicated by dashed lines, child system 6 may be part of or directly coupled to parent system 8. Also as indicated by dashed lines, secure system 4 may be directly coupled to content providers 10. A “system” according to elements 6 and 8 may be any mobile or fixed electronic device that is coupled to a network 12 that is utilized by a child and/or parent. Examples of such systems include a desktop computer, a laptop or notebook computer, a cellular phone, a personal digital computer, an electronic book, a television control device, or a dedicated game player. In some situations parents and children may share a system and then the child system 6 and the parent system 8 may be the same device but with different log on accounts. In other situations, the child system 6 and the parent system 8 are different electronic devices.

The secure system 4 is configured to generate web pages upon the child system 6 and the parent system 8 according to the present invention. The web pages provide the secure environment of the present invention and enable access to content providers

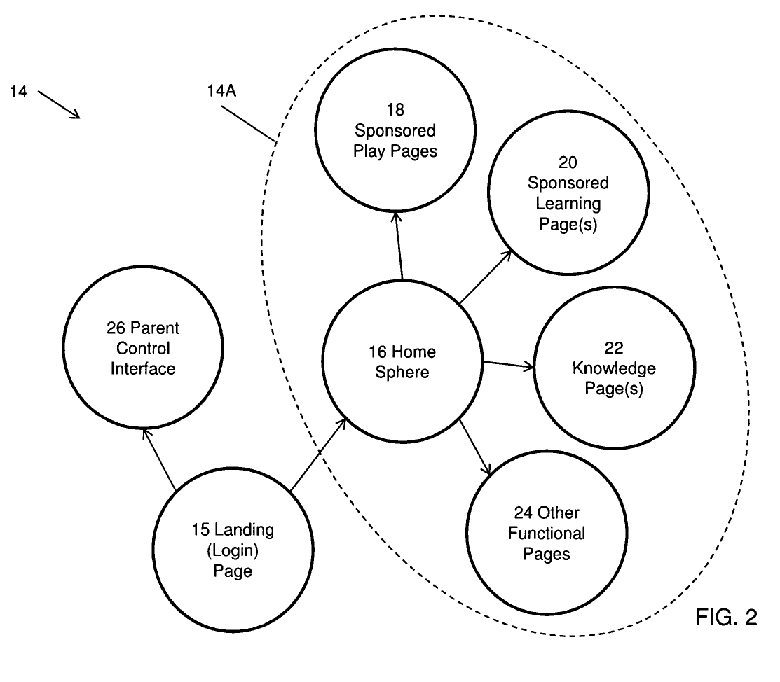

A web environment 14 provided by secure system 4 is depicted on FIG. 2. The web environment 14 is a virtual environment that is separately accessible by a child through a child interface 14A and a parent through a parent interface 26. More particularly, circles depicted in FIG. 2 are each indicative of one or more web pages generated on systems 6 and 8 when parents and children access web environment 14. A child or parent enters web environment 14 via landing page or login screen 15.

From landing page 15 a child may then proceed to home sphere 16. Home page or sphere 16 allows the child to customize her environment by selecting from among a number of themes. Within or from the home page 16 the child has access to a number of functions including chat, video, calendaring, and interactive characters that may fulfill inspirational tasks defined by a parent of the child. From the home page 16, the child may also access a number of other pages within child environment 14A including sponsored play pages 18, sponsored learning pages 20, knowledge pages 22, and other functional pages 24.

Sponsored play pages 18 are created by selected partners of the provider of the environment 14 to provide a particular environment with particular content. For example, a sponsor may provide branded content based upon a particular line of toys. A child may enter that environment from home page 16 and engage in a playdate within that particular environment.

Sponsored learning pages 20 are similar to sponsored play pages except that the content is based upon learning or academic subjects. Knowledge pages 22 provide references and resources to help a child with his homework.

The child may engage with a play date through any or all of web pages 18-24. The web pages 18-24 enable children to learn, create, play, and engage in a safe and compelling internet environment. Parents can improve safety and enhance their child's experience and development through parent control interface 26. Parents assure safety through parent control interface 26 by specifying or approving contacts, playdates, and content the child is exposed to. At the same time parents can use parent control interface 26 to enhance their child's online experience by selecting ways to inspire or provide incentives for their child.

When a parent decides to utilize environment 14, the first step is to set up a parent account. Once the parent has an account, the parent may then use interface 26 to set up a separate account for each of her children. For each child's account, the parent may use the interface 26 to establish a unique configuration that is age and developmentally appropriate.

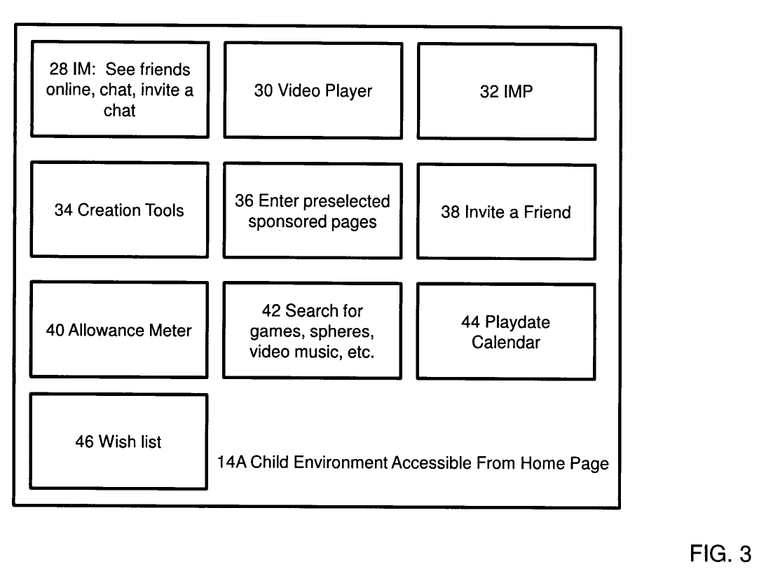

FIG. 3 depicts the enabled features or capabilities of a child environment or child interface 14A that is part of the online environment 14 depicted in FIG. 1 and is accessible via the home page 16. Each of elements 28-46 of FIG. 3 refer to features, capabilities, and software modules that enable aspects of child environment 14A. IM (instant messaging) module 28 enables the child to chat with contacts or friends that have been pre-approved via the parent control interface 26. Video player 30 provides a video library and a content management interface.

An IMP capability 32 refers to a character that is part of child environment 14A. IMP or I.M.P. refers to “Incredibly Magical People” that are computer generated characters with which the child interacts through the child interface 14A. When a child enters her home page she selects a theme. Based upon the theme selected, a certain type of IMP will be present as part of the home page. During the course of navigating or utilizing aspects of a theme-customized home page 16 the child will discover the associated IMP. In an alternative embodiment, the child may select the IMP.

The IMP interactions are built upon developmental aspects or guidelines for children including nurturing, challenging, playing, and structure. The IMP interactions are embedded into the child's selected theme to inspire abilities and to keep the visited web pages safe, interactive, and engaging. Before being able to move into sponsored web pages, the IMP will engage a child in activities that teach how to navigate, understand the rules of environment 14A and internet safety, and how to move into the sponsored web pages.

Creation tools 34 enable a child to make electronic greeting cards and similar items to send to contacts. Interface 36 enables a child to enter preselected (via parent control interface 26) sponsored pages as discussed with respect to elements 18 and 22 of FIG. 2.

Invitation module 38 enables a child to invite a contact or friend who has been approved via parent control interface 26 to a playdate web page (that can be a sponsored web page for example). Allowance or money meter 40 allows a child to track and enhance an allowance that has been enabled by parent control interface 26.

A search module 42 enables a child to search for items in child environment 14A. Calendar module 44 enables a child to track playdate invitations sent or received. Wishlist 46 enables a child to put items on a wish list for purchase or future gifts.

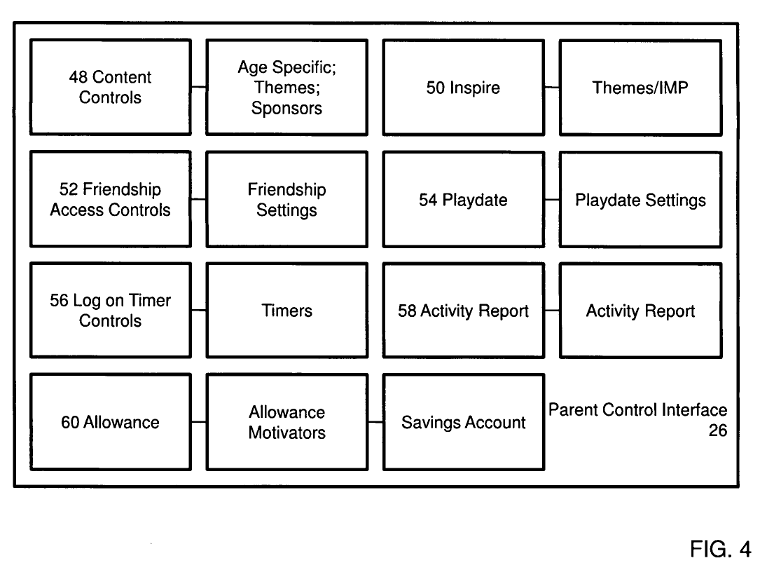

Elements 48-60 of FIG. 4 depict the features, capabilities, and software modules of parent control interface 26. Content controls 48 enable parents to specify age-specific content that their children will encounter including what themes and sponsors they have access to. In particular, control interface or module 48 is configured to enable a parent to enter information indicative of approved sponsored web pages 18 and 20 within which a child can have “virtual playdates.”

“Inspire Me” controls 50 enable a parent to select a category to inspire her child. An “Inspire Me” theme is performed via an IMP aligned to the theme that a child has selected for his home page. The “Inspire Me” control enables the parent to participate in her child's development through a category selection such as one of nurturing, challenging, playing, or providing structure.

Friendship access controls 52 define what contacts or friends have access to a parent's child. The parent can approve or reject the request of a potential contact to be an “anytime friend” who would unlimited access to set up playdates with their child. The parent can also select an “on approval only” feature that only allows playdates and contacts that the parent has approved.

Playdate access controls 54 allow parents to schedule playdates with their children's peers. Log on timer controls 56 enable parents to establish time limits for their children's access to the child environment 14A. Activity report controls 58 allow a parent to specify what kind of reporting is desired to keep track of his child's activities. Allowance controls 60 allow a parent to set up an allowance for her child and to specify aspects of the allowance such as a periodic amount and associated motivators.

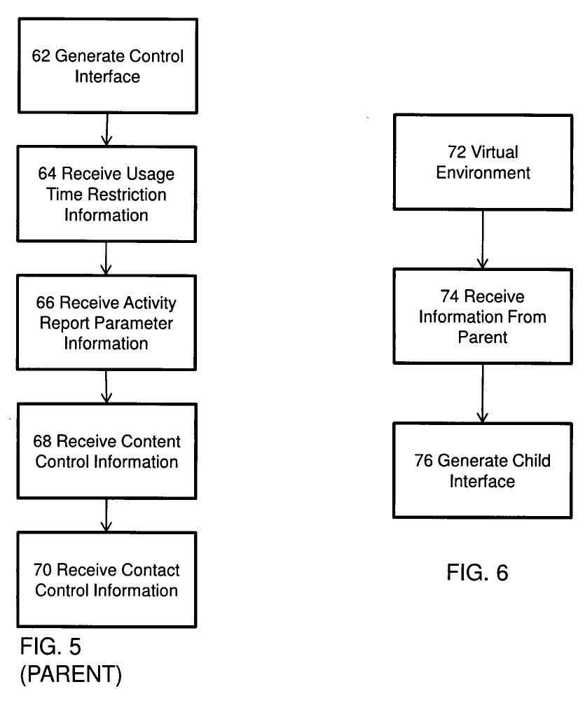

FIG. 5 is a flow chart representation of the process through which a parent sets up or establishes controls on the child environment 14A. These steps can occur in any order and the order is not limited to the one indicated in FIG. 5. According to 62, parent control interface 26 is displayed upon parent system 8. Parent control interface provides the tools or modules 48-60 discussed with respect to FIG. 4. According to steps 64, 66, 68, and 70, secure system 4 receives information indicative of various selections a parent makes using parent control interface 26.

According to 64, usage time restriction information is received from parent system 8 when a parent utilizes log on timer controls 56. Based upon the usage time restriction information system 4 limits access times to a child environment 14A for a given child account.

According to 66, activity report parameter information is received from parent system 8 when a parent utilizes activity report controls 58. Based upon the activity report parameter information system 4 will or will not provide reports to parent system 8 based upon a child's activities in child environment 14A. The activity report parameter information may also determine various aspects of the reports such as type of, detail contained in, and frequency of reports.

According to 68, content control information is received from parent system 8 when a parent utilizes content controls 48. Based on the content control information, system 4 enables a selection of content, themes, and sponsors to be accessed within environment 14A for a given child. Some of the content control information is indicative of web pages including sponsored web pages 18 and 20 within which the child may enter into and engage in playdates within.

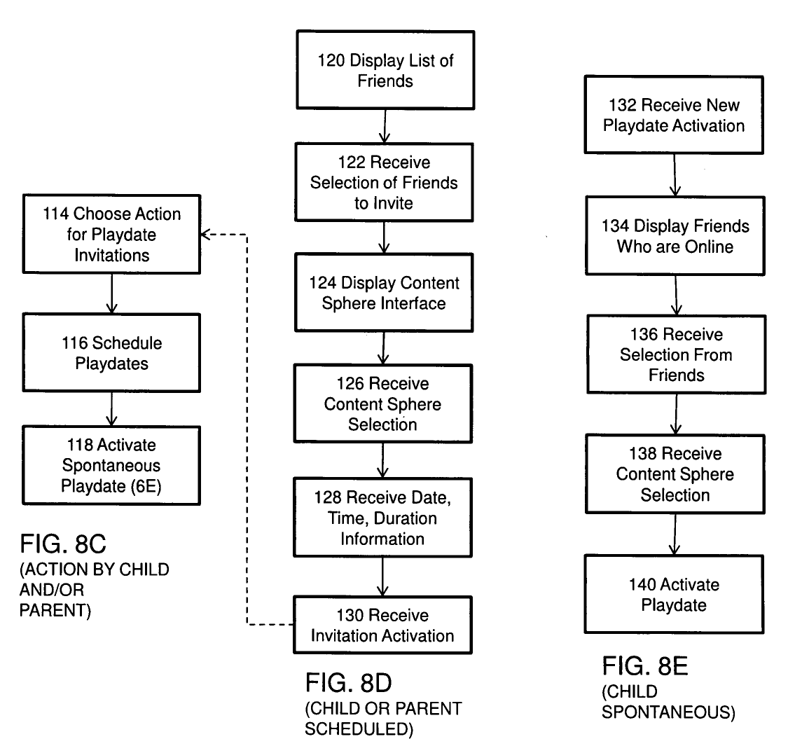

According to 70, contact control information is received from parent system 8 when a parent utilizes Friendship Access Controls 52. Contact control information will be discussed again with respect to FIGS. 8A and 8B.

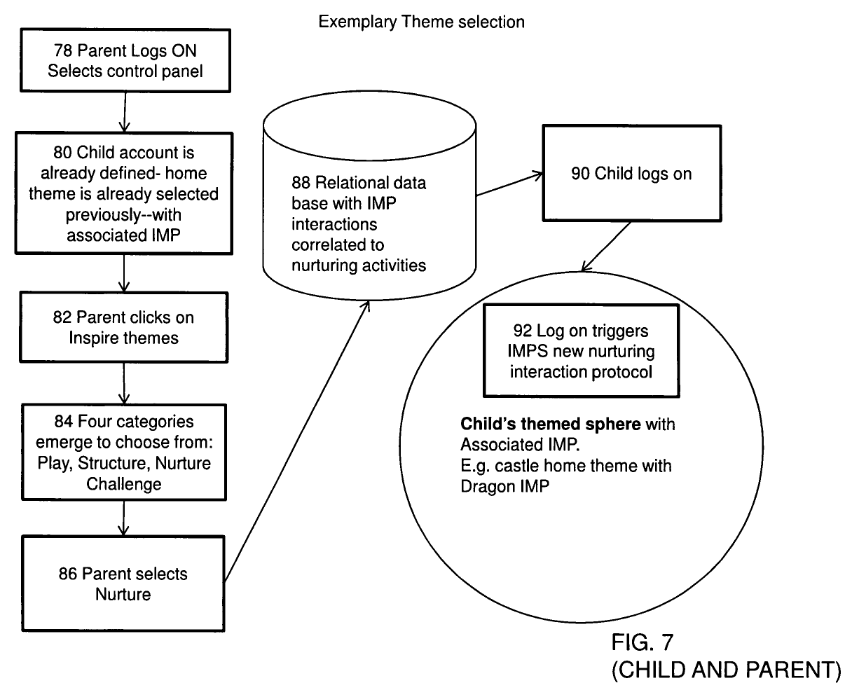

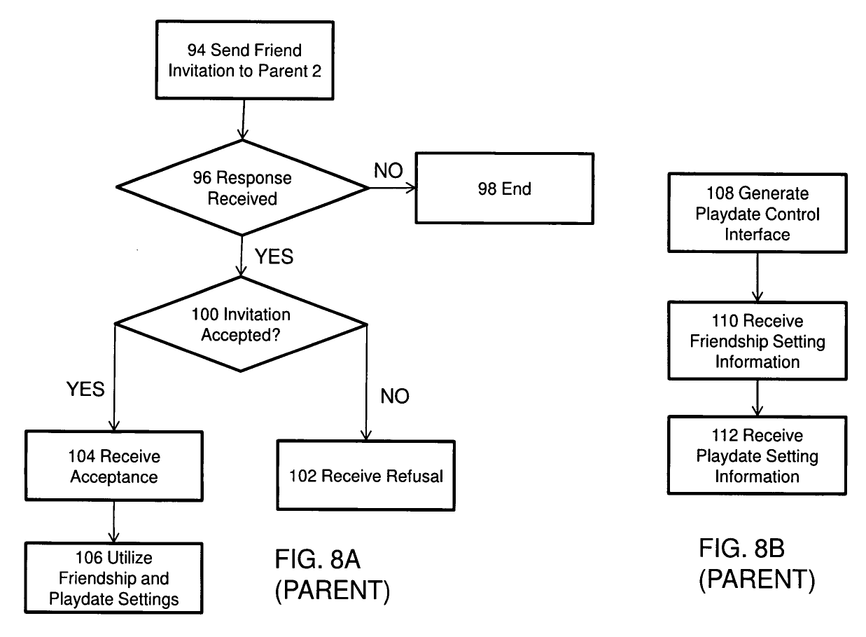

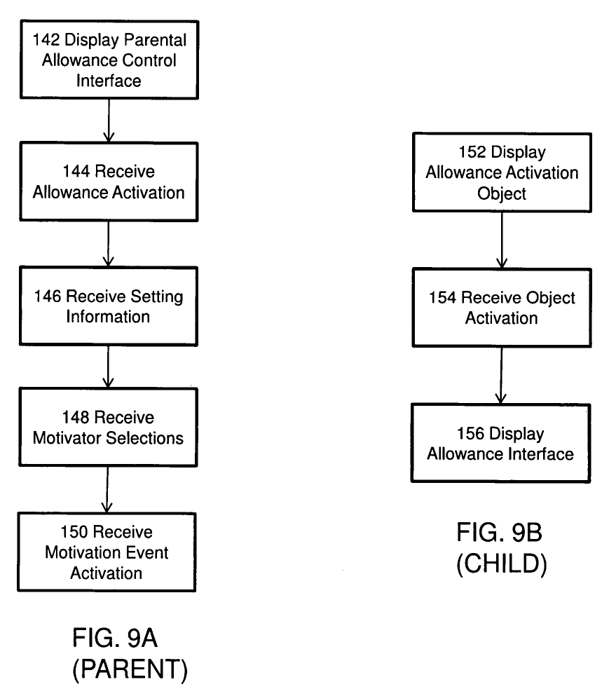

FIG. 6 is a flow chart representation of a method of providing developmental opportunities for a child. According to 72, a virtual environment 14 is provided that is separately accessible by a parent through a parent control interface 26 and by a child through a child interface 14A including home sphere 16. According to 74, system 4 receives information from the parent using parent control interface 26 that defines a developmental objective that is one of a plurality of possible developmental objectives. According to 76 system 4 generates the child interface having a feature or attribute that encourages the developmental objective. More specific examples of the method of FIG. 6 are described with respect to FIGS. 7, 9A, and 9B.

FIG. 7 is a process flow representation of a parent using inspire module 50 of FIG. 4. According to 78, a parent logs in to parent control interface 26 and selects module 50. In response to receiving a log on and selection, system 4 generates inspire module interface 50.

According to 80, the parent has a child whose account is already defined within environment 14. The child has already selected a theme that has an associated IMP. In the depicted example, the theme is a castle theme with a dragon as an IMP.

According to 82, the parent uses module 50 to select an inspire theme category. In response system 4 displays a plurality of categories on parent system 8 according to step 84. In an exemplary embodiment the categories include play, structure, nurture, and challenge. According to step 86 the patent selects a category such as the nurture category.

According to 88, a relational database is utilized by system 4 that correlates IMP interactions with nurturing activities. According to 90, the child logs on to environment 14. According to 92, the log on triggers a new IMP nurturing protocol that is defined by database 88 based upon the IMP that the child selected and the nurturing category selected by the parent.

FIGS. 8A-E depict a playdate function of environment 14. FIG. 8A is a flow chart representation of a method by which a first parent having a first child utilizes Friendship Access Controls 52 to invite a second child having a second parent the first child's playdate. According to 94 the first parent sends a friendship invitation to the second parent. This is accomplished by inputting either the IMP name for the second child or the email address of the second parent.

If the second parent does not respond, the process stops according to 96 and 98. According to 96, 100, and 102, a response is received whereby the second parent refuses the invitation. According to 96, 100, and 104, a response is received wherein the second parent accepts the invitation. According to 106, receipt of an acceptance typically results in use of friendship and playdate settings by the first parent. Use of friendship and playdate settings will be described with respect to FIG. 8B. Pursuant to steps 104 and 106, the second child is referred to as a Friend of the first child.

FIG. 8B is a flow chart representation of a method by which a first parent of a first child utilizes friendship access control module 52 to define playdate settings for a second child having a second parent wherein the second child is a Friend according to the method of FIG. 8A. According to 108, system 4 generates a friendship access control interface 54 on parent system 8. The friendship access control interface 54 allows the first parent to define Friendship Settings for the Friend. The following are some exemplary Friendship Settings that may be selected using the interface generated in step 108:

### Friends

Allow child to participate with this Friend (second child) in scheduled Playdates (Yes/Ask Each Time)
Allow child to participate with this Friend in Spontaneous (child created) Playdates (Yes/No/Ask)
   As a note, Spontaneous Playdates are defined with respect to FIGS. 8C and 8E.
Allow child to send and receive IM's (instant messages) from this Friend (Yes/No)
Allow child to exchange content with this Friend (Yes/No)
Apply the above settings to all Friends (Yes/No)

### Secondary Friends

Allow child to participate with this Friend (Primary Friend meaning the second child), and with the Friend's Friend (defined as a Secondary Friend) in Scheduled Playdates (Yes/No/Ask)
Allow child to participate with this Primary Friend, and with a Secondary Friend, in Spontaneous Playdates (Yes/No/Ask)

Now according to 110, the first parent utilizes friendship access control interface 52 to select the settings such as those indicated above for a Friend. Based upon those selections, system 4 receives Friendship Setting Information. The friendship access control interface 54 also enables the first parent to input playdate settings that are not limited to any single Friend. The following are some exemplary Playdate Settings.

### PlayDate Settings

Allow child to participate in Playdates with content not in my approved content list (yes/no/ask)
Allow child to generate spontaneous playdates with approved Friends (yes/no)
Time Limits—Limit playdates to minutes (15/30/45/60/end of session)

According to 112, the first parent utilizes friendship access control interface 52 to select playdate settings such as those indicated above. While the above description depicts step 112 following step 110 it is to be understood that step 112 can be performed before step 110 or portions of steps 110 and 112 can be performed in any order using playdate control interface. Based upon steps 110 and 112, system 4 receives playdate related parameters from parent system 8 that include Friendship Setting information and/or Playdate Setting Information.

When a child has a Friend as defined above, she and/or her parent may accept, schedule, or have spontaneous playdates pursuant to the settings as described above. FIG. 8C depicts a general method by which a child may obtain a playdate with a Friend. According to 114 a parent or her child may review a list of playdate invitations from other parents or other children. From this interface, the parent or child may decide to accept, decline, suggest reschedule, or suggest a location change for the playdate.

According to 116, the parent or child may schedule a playdate. The entire process of scheduling a playdate is depicted in flow chart form in FIG. 8D. According to 118, the child may elect to have a spontaneous playdate as will be described in more detail with respect to FIG. 8E.

FIG. 8D is a flow chart representation of a process by which a parent or child schedules a playdate. If the child schedules a playdate then this is performed by the child using child interface 14A. If this is performed by the parent then this is performed using playdate control interface 54.

According to 120 system 4 displays a list of Friends (those approved by the parent as potential playdates) on system 6 or 8. According to 122, the parent or child selects from the list of Friends and thus system 4 receives information indicative of the Friends who have been selected. According to 124, system 4 displays a list of content pages on system 6 or 8. According to 126, the parent or child selects a content page and thus system 4 receives information indicative of the content page that has been selected. According to 128, the parent or child selects a date, time and duration for the playdate. According to 130, the parent or child submits the invitation. As indicated by the dashed arrow, the Friend will then receive an invitation according to 114 of FIG. 8C.

FIG. 8E is a flow chart representation of a process whereby a child activates a spontaneous playdate. According to 132, system 4 receives a request from child system 6 to create a new playdate. System 4 then displays a list of Friends who are on line or may be on line according to 134. According to 136 the child makes a selection from among the list. According to 138 the child makes a content page selection for which to have the playdate. If any Friends are subject to a content restriction the system will then send a notification to child system 6. Otherwise, system 4 activates or starts the Spontaneous playdate between the child and the selected Friend, if in fact the Friend is online according to 140.

FIGS. 9A-B are flow chart representations depicting the allowance aspect of environment 14. FIG. 9A is a flow chart representation of the method by which a parent sets up an allowance for a child. According to 142, system 4 displays parent allowance control interface 60 on parent system 8. This interface enables the following inputs:

### General Allowance Settings—STEP 144 and 146

Allowance Status (enable/disable)—STEP 144
Allowance Account Balance
Child's Current Allowance Balance
Child's Pending Allowance

### Inspire Motivators—STEP 148

List of Active Inspire Events and Allowance Attached to Each
Option to Enable Duration for Event Completion (Deadline to Obtain Allowance)
Option to Add New Inspire Event

### Homework—STEP 148

List of Active Homework Projects and Allowance Attached to Each
Option to Enable Duration for Event Completion (Deadline to Obtain Allowance)
Option to Enable Amount of Allowance Awarded Based on Homework Performance

Settings above are selected by the parent using this interface 60 according to steps 144, 146, and 148. According to 144, the allowance is activated. General allowance setting information is received from parent system 8 according to 146. According to 148, inspire and/or homework motivator setting information is received from parent system 8. According to 150, a motivation event activation is received from parent system 8.

FIG. 9B is a flowchart representation of the child accessing the allowance feature 40. According to 152, an allowance activation object such as an icon is displayed on child system 6. According to 154, the child activates the object. According to 156 allowance interface 40 is displayed on child system 6. The interface may display the following information.

### Money Meter Interface 40

Current Allowance Total
Active Allowance Motivators
   Each Active Allowance Activity
   Duration of Each Event
   Allowance to be Earned for Each Event
Link to Web Page Allowing Use of Allowance

1. A method of enabling a child to have virtual playdates with other children comprising:
providing a virtual environment separately accessible by a parent of the child through a parent control interface and the child through a child interface;
receiving playdate control information from the parent using the parent control interface; and
enabling the child to have the virtual playdates based on a scope defined by the playdate control information.

2. The method of claim 1 wherein the playdate control information defines other children the child may have scheduled playdates with.

3. The method of claim 1 wherein the playdate control information defines other children the child may have spontaneous playdates with.

4. The method of claim 1 wherein the playdate control information defines what other children the child may exchange content with.

5. The method of claim 1 further comprising receiving information from the parent defining approved content for the child.

6. The method of claim 5 wherein the playdate control information determines whether the child may participate in playdates with content that is not approved content.

7. The method of claim 1 wherein the playdate control information defines other children the child may exchange instant messages with.

8. A secure system configured to provide the method of claim 1.

9. A method of enabling a first child to have a virtual collaboration with a second child using an online environment:
receiving an initial approval from a second parent system enabling the first child to interact with the second child; and
receiving an additional approval from a first parent system defining parameters governing the virtual collaboration between the first child and the second child.

10. The method of claim 9 wherein the second parent system is operated by a parent of the second child.

11. The method of claim 9 wherein the initial approval is in response to a message from a parent of the first child.

12. The method of claim 9 wherein the first parent system is operated by a parent of the first child.

13. The method of claim 9 wherein the additional approval defines which of a plurality of web pages that the virtual collaboration may take place in.

14. A secure system configured to provide the method of claim 9.

15. A method of enabling interaction between a child and other children within a virtual environment comprising:
receiving a first approval defining friends that the child may interact with; and
receiving a second approval defining parameters governing the interaction.

16. The method of claim 15 further comprising receiving an approval from a parent system operated by a parent of one of the other children, the approval allowing one of the other children to interact with the child.

17. The method of claim 15 wherein the second approval defines whether the interaction includes a scheduled playdate.

18. The method of claim 15 wherein the second approval defines whether the interaction includes a spontaneous playdate.

19. The method of claim 15 wherein the second approval defines content that may be used in the interaction.

20. The method of claim 15 wherein the second approval defines one of more of a plurality of web pages within which the interaction can take place.
